(19) United States
(12) Patent Application Publication
(10) Pub. No.: US 2004/0251354 A1
(43) Pub. Date: Dec. 16, 2004

(54) A grinder body presenting comprising concave protions

(76) Inventor: Benjamin Cambier, Le Parcq (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/432,518

(22) PCT Filed: Nov. 23, 2001
(86) PCT No.: PCT/FR01/03709

(30) Foreign Application Priority Data
Nov. 24, 2000 (FR) 00/15238

(51) Int. Cl. B02C 17/14

(52) U.S. Cl. 241/184

(57) ABSTRACT

The present invention relates to a grinder body of the spherical type inscribed in a sphere (S) of radius R and including concave portions disposed in such a manner as to avoid altering the center of gravity of the sphere. In characteristic manner of the invention, the maximum depth (h) of the concave portions lies substantially in the range 1/12th to 1/18th of the radius R of said sphere (S). The present invention also provides a method of grinding that implements the grinder body of the invention, and a ball mill containing a grinding mass that includes grinder bodies of the invention.

The present invention relates to a grinder body of the spherical type for use in a “ball” mill. More particularly, the present invention relates to a spherical type grinder body which can advantageously be used in a mill whose inside surface is made up of metal cladding for distributing the grinding load.

The present invention also relates to a grinding method implementing the above-specified grinder body.

In general, in a “ball” mill, grinding is performed by two actions.

The first action is comminution. It corresponds to coarse reduction of the raw material for grinding; it absorbs 35% to 40% of the energy of the mill and is performed mainly by the balls dropping onto the raw material for grinding and on the mixture of raw material for grinding and balls resting in the bottom of the barrel of the mill. About ⅓rd of the balls contained in the mill are raised and drop under the effect of their own weight onto the raw material to be ground and/or onto the balls that remain in the bottom part of the mill. The energy released by the falling balls serves to break up the raw material for grinding in coarse manner. For comminution to be effective, the first compartment of the mill or the head of a single-compartment mill is provided with balls of large diameter, e.g. 90 millimeters (mm) to 60 mm.

The second action is attrition. This corresponds to finely reducing the raw material for grinding. Attrition is performed mainly by friction between the balls that remain in the bottom of the mill and that are covered in particles of the raw material for grinding, and by friction between the balls and the inner metal cladding of the mill. Attrition absorbs 60% to 65% of the energy needed for grinding the raw material.

In order to increase the efficiency of the mill, it has already been recommended to increase the area of contact between the grinding bodies and the raw material for grinding. Thus, document FR 2 062 716 describes a grinder body having concave portions and convex portions. That document describes convex portions of the grinder body co-operating with concave portions of another grinder body of the same type so as to reduce the raw material for grinding in the manner of a pestle and mortar. Since the wear of the convex portions of the grinder body is greater than that of the concave portions, according to the above-cited document it is necessary to make the convex portions out of a material that is harder than the material used for making the concave portions. The use of two different materials or the treatment needed to obtain differing hardnesses different portions of the grinder body necessarily make the manufacture of such a grinder body difficult and expensive. Furthermore, because of the presence of the above-described concave and convex portions, there are non-negligible risks of the above-mentioned grinder body jamming, either on grinder bodies that have broken or become deformed, or on foreign bodies, and this can make it impossible for the mill to operate.

In the preferred example described and shown in the above-mentioned document, the grinder body has concave portions of a depth of about 20% of the radius of the sphere in which the grinder body is inscribed. In addition, the concave portions occupy about 50% of the total surface area of said sphere. The Applicant has shown that although the presence of such concave portions theoretically increases the contact or active area between the grinder bodies and the raw material to be ground, it also leads to the formation of a thick layer of the raw material for grinding, which material is received in the concave portions of the grinder body. The thick layer has a damping effect, thereby dissipating energy, and thus greatly reducing the efficiency of the comminution action. In addition, tamping occurs, i.e. said thick layer of raw material for grinding that is received in the concave portions of the grinder bodies becomes compacted, thereby forming plugs of compacted material which remain stuck in the concave portions, thereby reducing the efficiency and the performance of the mill.

Furthermore, document SU 1 731 276 describes a grinder body having cavities of depth defined as a function of the number of cavities and of their width.

The object of the Applicant is to propose a grinder body of the spherical type having concave portions, a mill fitted with such grinder bodies, and a grinding method implementing such grinder bodies, all enabling the above-mentioned drawbacks to be remedied.

This object is achieved firstly by means of a grinder body which, in known manner, is inscribed in a sphere of radius R and has peripheral concave portions; in a manner characteristic of the invention, the maximum depth of the concave portions lies substantially in the range 1/12th to 1/18th of the radius R of the sphere.

The formulae mentioned in above-mentioned document SU 1 731 276 do not define a maximum depth lying in this range.

The concave portions are naturally disposed in the periphery of the grinder body in such a manner as to avoid shifting its center of gravity.

The Applicant has found that having shallow concave portions makes it possible firstly to obtain wear of the grinder body of the invention that is uniform without requiring differing hardnesses for the convex portions and the concave portions, and secondly makes it possible to obtain a thin layer of raw material for grinding in the concave portions that serves to improve the performance of the mill in its attrition action without giving rise to a drawback in its comminution action. Since these concave portions are shallow, they do not run the risk of becoming clogged with compacted fine material and they thus make it possible in all cases to lift a portion of the raw material. The concave portions become filled with fine raw material which is entrained when the grinder bodies are lifted and falls together with them, thus leading to greater homogenization of the raw material for grinding. In addition, because of the internal ventilation system in the mill, the fines lifted in this way are removed, thus making it possible, inside the mill, to maintain raw material for grinding in optimum quantity and grain size.

Advantageously, in the invention, for concave portions in the form of spherical caps, the total area of said concave portions lies in the range 5% to 25% of the total surface area of the sphere. Thus, in the invention, the total active surface area, i.e. of all of the grinder bodies used in the mill, is increased, but without leading to the drawbacks associated with using prior art grinder bodies.

In a mill having spherical grinder bodies, it is conventional to use batches of grinder bodies having different diameters, for example 90 mm to 60 mm for the first compartment or the first sector so as to enhance the comminution action, and 50 mm to 17 mm for the second compartment or the second sector of the mill so as to enhance the attrition action, giving an overall range of 90 mm to 17 mm. It is found that when using grinder bodies of the invention, the mill achieves excellent efficiency with a much narrower range of sizes, preferably 90 mm to 60 mm, or indeed 70 mm to 60 mm.

The grinder body of the invention preferably has an odd number of concave portions greater than or equal to three and less than or equal to seven. This small number of shallow concave portions does not impede the ability of the grinder body to roll.

The concave portions need not necessarily be spherical in shape. Thus, the concave portions may form rolling paths.

In a preferred embodiment, with concave portions of spherical shape, the concave portions are defined by the intersection between the sphere of radius R in which the grinder body is inscribed and a sphere of radius R′ which is slightly greater than R. This particular disposition makes it possible to be certain that the spherical portions (of radius R) of a grinder body can be received in the concave portions (of radius R′) of a grinder body of the invention, particularly during attrition action, and regardless of variations in diameter due to problems of tolerance during manufacture of the grinder body.

A difficulty raised in the grinder bodies of document FR 2 062 716 can lie in the major risk of flaking in the edges around the concave portions. In the invention, the edges of the concave portions are curved and the junction zone between the surfaces of the concave portions and the surface of the sphere has a connecting radius r of about 5 mm.

In a first variant embodiment, the grinder body has a diameter substantially equal to 90 mm, and includes three concave portions of maximum depth lying in the range 2.5 mm to 3.5 mm.

In a second variant, the grinder body has a diameter lying in the range 50 mm to 60 mm, preferably being equal to 50 mm or to 60 mm, and has three concave portions of maximum depth lying in the range 2 mm to 3 mm.

The present invention also provides a grinding method in which, in characteristic manner, the raw material is introduced into a mill containing a multiplicity of grinder bodies as defined above and in which a flow of ventilation fluid is caused to pass through the mill at a speed lying in the range 2.5 meters per second (m/s) to 5 m/s. The Applicant has also shown that using grinder bodies of the invention requires ventilation to be stronger in order to avoid the mill clogging and/or any reduction in throughput. Implementing ventilation as specified above makes it possible to extract the finest particles from the mill as soon as they are formed and/or as soon as they are lifted, and as a result it makes it possible to maintain the raw material for grinding inside the mill at a quantity and grain size that are optimum.

The mill used in the method of the invention preferably presents load-distributing metal cladding that takes advantage of the property of the grinder bodies of the invention whereby they are capable of being classified in part by size. This makes it possible to adapt the active surface area of the multiplicity of grinder bodies (also referred to as the grinding mass) to the grain size of the raw material for grinding.

In a first variant implementation of the method of the invention, the raw material for grinding contains 0 to 6% by weight of water.

In a second variant implementation, the raw material for grinding contains 25% or more by weight of water.

The present invention also provides a mill containing a grinding load comprising a mixture of conventional spherical grinder bodies and grinder bodies having concave portions in accordance with the invention. The mixture preferably comprises 25% to 50% grinder bodies of the invention.

The present invention will be better understood and its characteristics and advantages will appear more clearly on reading the following description given with reference to the accompanying drawings presenting a preferred embodiment of a grinder body of the present invention which is shown by way of non-limiting example, and in which:

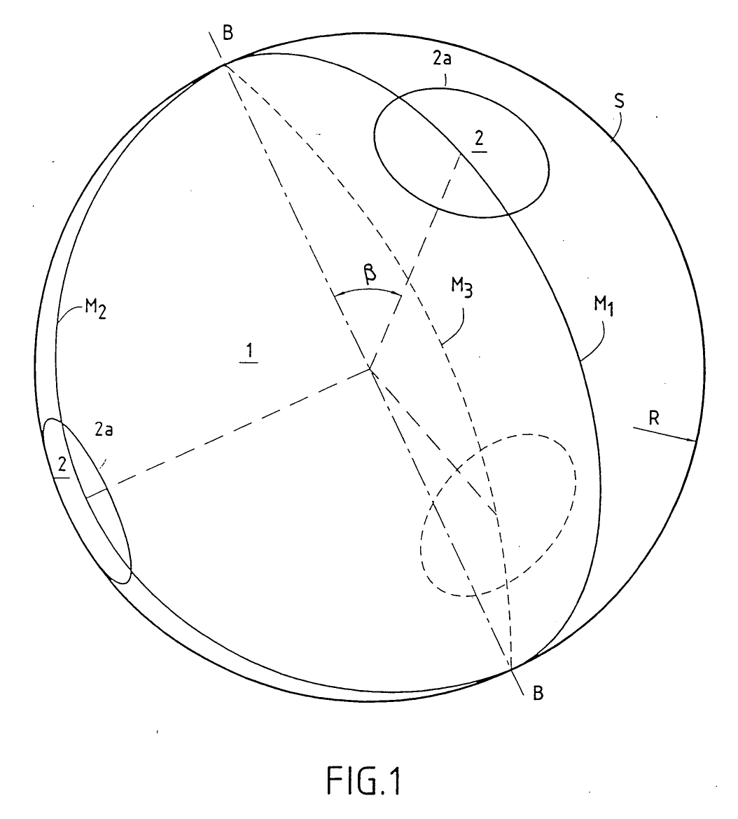

FIG. 1 is a general view of a preferred embodiment of a grinder body of the present invention;

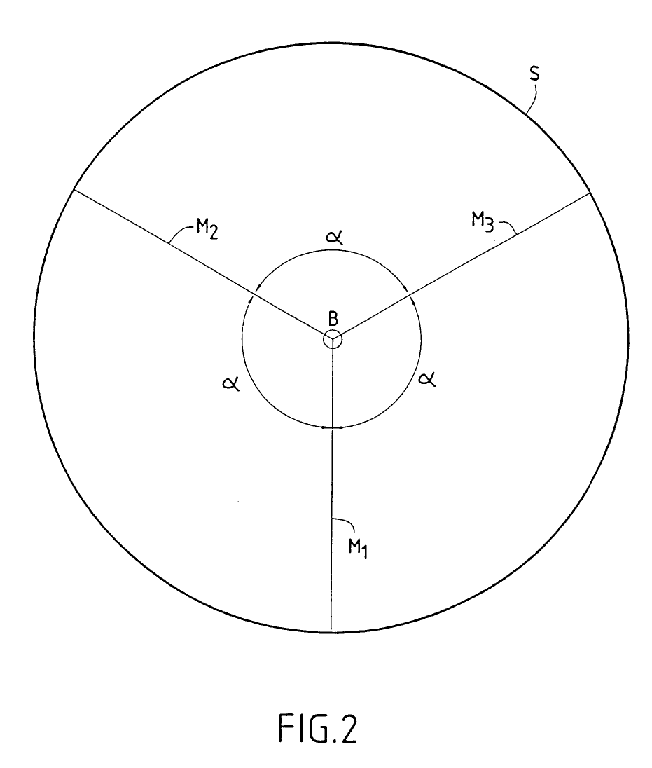

FIGS. 2 to 5 show one example of how the cavities are disposed in the embodiment shown in FIG. 1;

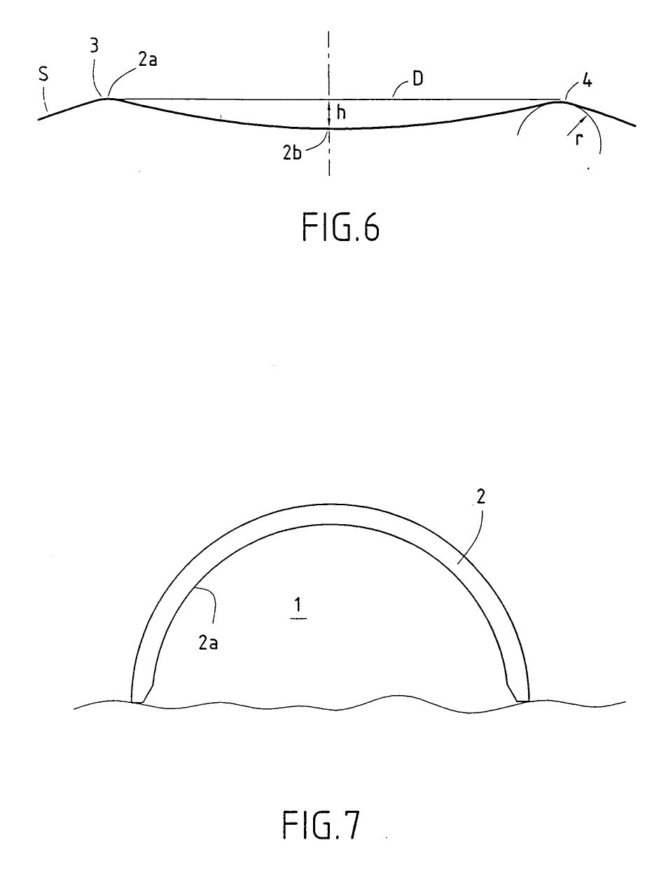

FIG. 6 shows a concave portion of the FIG. 1 grinder body in greater detail; and

FIG. 7 is a fragmentary view of a second variant embodiment of the grinder body of the invention.

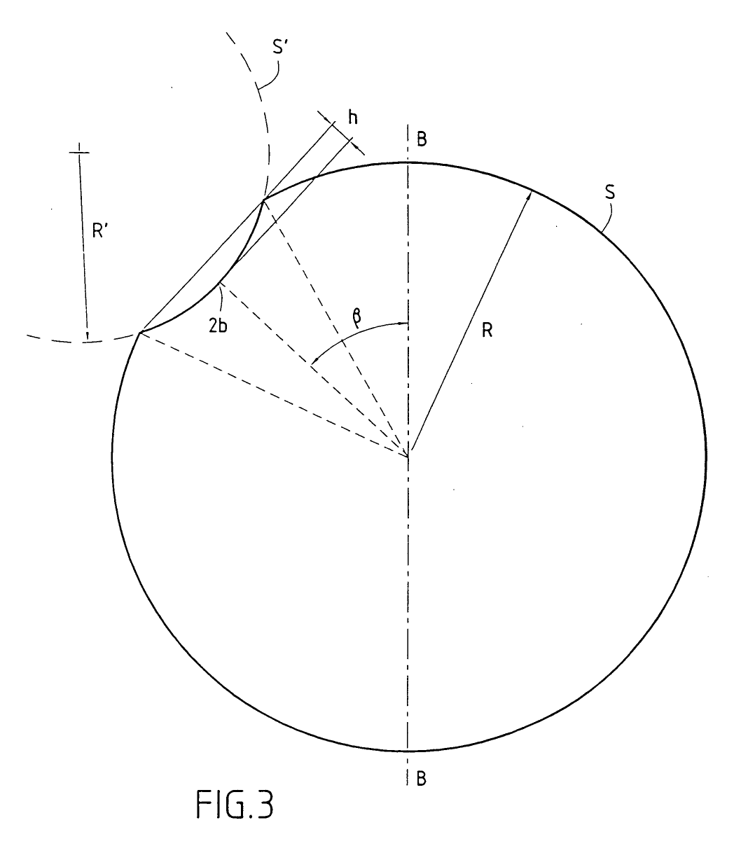

With reference to FIG. 1, the grinder body 1 of the invention is inscribed in a sphere S of radius R. Concave portions 2 are formed at the periphery of the grinder body in a disposition that does not change the center of gravity of the sphere S. The concave portions 2 may be defined as the intersection between the sphere S with a sphere S′ presenting a radius R′ which could in theory be equal to R (visible in FIG. 3), but which in practice is made to be slightly greater than the radius R during manufacture so that when the mill is in operation it is certain that a convex curved portion of a first grinder body can be received in the concave portion 2 of a second grinder body. For example, the radius R′ of the sphere S′ is made to be equal to R plus 1 mm. In the first embodiment shown in FIG. 1, the concave portions 2 thus present respective circular edges 2a.

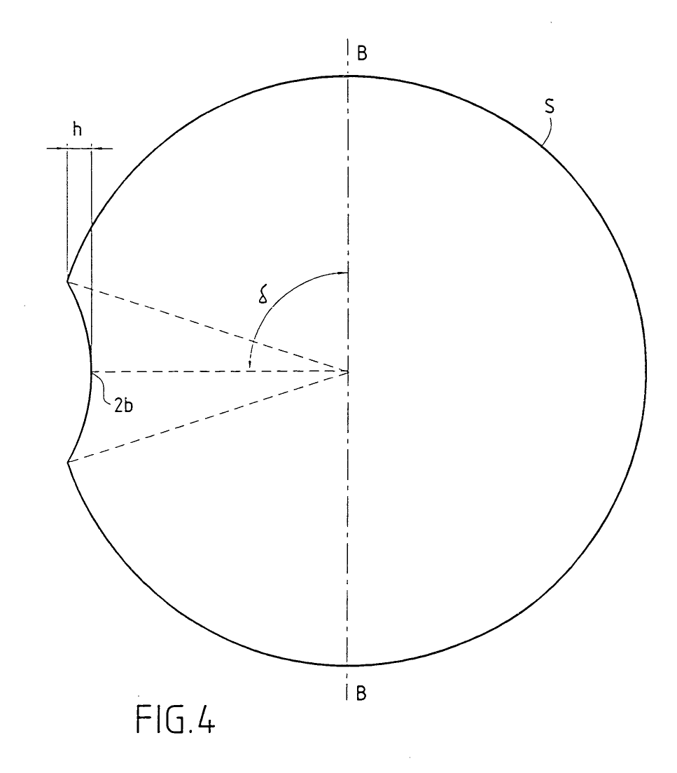

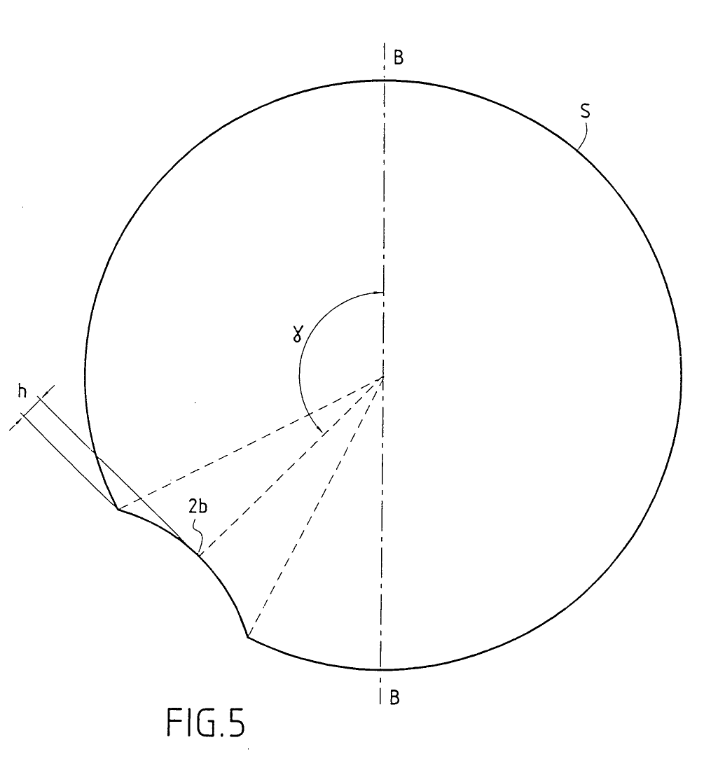

In the example shown with reference to FIGS. 2 to 5, the grinder body 1 has three concave portions 2 of positions defined as a function of three meridians M1, M2, and M3 which are offset from one another by an angle α of 120°, as can be seen in FIG. 2. With reference to FIG. 3, the bottom 2b of the first concave portion 2 is situated on a radius of the sphere S that lies in the plane containing the first meridian M1 and forming an angle β of 45° relative to the central axis B-B common to all three meridians. In the same manner, with reference to FIGS. 4 and 5, the bottoms 2b respectively of the second and third concave portions 2 are situated respectively on radii lying in planes containing the second and third meridians M2 and M3 and forming respective angles δ and γ of 90° and 135° with the central axis B-B. The bottom 2b of each of the concave portions 2 is defined as being the point of minimum radius relative to the center of the sphere S.

With reference to FIG. 6, the maximum depth h of the concave portions 2 is measured as being the distance between the bottom 2b of the concave portion 2 and a straight line D interconnecting two diametrically opposite points 3 and 4 on the edge 2a of the concave portion 2. At the edge 2a, the junction zone 5 between the surface defining the concave portion 2 and the surface of the sphere S is rounded and presents a radius of curvature r of about 5 mm.

In a first example, a mill was fitted with a grinder mass comprising a multiplicity of grinder bodies of the invention having a maximum radius RM of 45 mm and a minimum radius Rm of 30 mm. The concave portions of each of the grinder bodies were defined by the intersections between the sphere in which said grinder body is inscribed and a sphere S′ having a radius equal to 46 mm. Thus, regardless of the radius of the grinder body, the sphere S′ presented a radius of 46 mm, i.e. a radius perceptibly greater than the maximum radius RM. The maximum depth of the concave portions was 3.5 mm for a grinder body having a radius of 45 mm, of 3 mm for a grinder body having a radius of 40 mm, of 2.5 mm for a grinder body having a radius of 35 mm, and of 2 mm for a grinder body having a radius of 30 mm; tolerance on all these dimensions was 0.5 mm.

In a second example, the grinder bodies had a radius either of 30 mm or of 35 mm. In that case, the concave portions were defined, regardless of the radius of the grinder body, by the intersection between the sphere S defining the grinder body and a sphere S′ of radius equal to 36 mm. The maximum depth of the concave portions in this case was 3.5 mm for a grinder body presenting a radius of 35 mm, and 3 mm for a grinder body presenting a radius of 30 mm; tolerance for all of these dimensions was 0.5 mm.

In both of the above examples, the other characteristics of the grinder bodies, i.e. the radius of curvature of the edges 2a of the concave portions and the disposition of the concave portions were as defined with reference to FIGS. 1 and 2. Choosing such proportions for the concave portions 2 made it possible to obtain rolling with standard spherical grinder bodies within the concave portions of the grinder bodies of the invention and rolling of grinder bodies of the invention within the concave portions of other grinder bodies of the invention, regardless of their respective radii.

With reference to FIG. 7, in a second variant embodiment, the concave portions form elongate rolling paths 2 each covering a hemisphere. The cross-section of such rolling paths is defined as a spherical cap. The maximum depth of these rolling paths 2 is about 1/15th the radius R. For example, this depth is about 2 mm for a grinder body inscribed in a sphere S of radius 30 mm. Similarly, the edge 2a defining a rolling path is rounded as described above. The shape, and in particular the width, of the rolling paths is selected in such a manner as to obtain the thin-layer effect between two balls, i.e. an adjacent ball can co-operate with a rolling path 2 so as to contribute to the attrition of the raw material that is to be ground. The width of the rolling path (its chord) is a function of its depth. For example, for a depth of 3 mm, the chord is equal to 32.25 mm. The rolling paths 2 are disposed in such a manner as to avoid shifting the center of gravity of the sphere S. By way of example, the rolling paths may be disposed as descried above with reference to FIG. 2, relative to the meridians M1, M2, and M3 of the sphere S. When using rolling paths 2, the bottoms of the concave portions are no longer restricted to a single point, but rather occupy a curved line 2c making it possible, while co-operating with an adjacent grinder body, to grind the raw material finely over a larger area than is possible with circular concave portions.

The grinder body of the invention may also have both of the two above-described types of concave portion.

The grinder body of the invention should be made in such a manner as to avoid shifting the center of gravity of the sphere in which it is inscribed. It is therefore cast in such a manner as to avoid any shrink cavity, for example by the shell or the vibratory casting method.

In order to maintain the characteristics of the grinder body over time, the steel needs to be treated (highly alloyed).

1/ A grinder body of spherical type inscribed in a sphere (S) of radius R and including concave portions (2) disposed in such a manner as to avoid modifying the center of gravity of said sphere, wherein the maximum depth (h) of said concave portions lies substantially in the range 1/12th to 1/18th of said radius R of said sphere (S).

2/ A grinder body according to claim 1, wherein the total surface area of said concave portions lies in the range 5% to 25% of the total surface area of said sphere.

3/ A grinder body according to claim 1 having an odd number of concave portions greater than or equal to three and preferably less than or equal to seven.

4/ A grinder body according to claim 1, wherein said concave portions form rolling paths.

5/ A grinder body according to any one of claims 1, wherein each of said concave portions is defined by the intersection of said sphere (S) with a sphere (S′) having a radius (R′) that is perceptibly greater than the radius (R) of said sphere (S).

6/ A grinder body according to claims 1, wherein the edges of said concave portions are curved, the junction zone between the surface of a said concave portion and the surface of the sphere (S) presenting a radius of curvature (r) of about 5 mm.

7/ A grinder body according to claim 1, wherein said sphere (S) presents a diameter substantially equal to 90 mm, the maximum depth of said concave portions being greater than or equal to 2.5 mm, and less than or equal to 3.5 mm.

8/ A grinder body according to any one of claim 1, wherein said sphere (S) presents a diameter that is substantially equal to 60 mm, the maximum depth of said cavities being greater than or equal to 2 mm, and less than or equal to 3 mm.

9/ A grinder body according to claim 1, having three concave portions with bottoms disposed on radii of the sphere (S) situated respectively in the planes of first, second, and third meridians (M1, M2, M3) defined relative to the central axis (B-B), said first meridian (M1) forming an angle (β) of 45° with said central axis (B-B), and said second and third meridians (M2; M3) forming respective angles (δ; γ) of 90° and of 135° with said central axis (B-B).

10/ A method of grinding a raw material, wherein said raw material is introduced into a mill containing a multiplicity of grinder bodies as defined in claim 1, and in that a ventilation fluid flow is caused to pass through said mill at a speed lying in the range 2.5 m/s to 5 m/s.

11/ A ball mill containing a grinder mass comprising spherical grinder bodies and spherical grinder bodies having concave portions in accordance with claim 1.

12/ A mill according to claim 11, containing grinder bodies of different diameters, wherein the concave portions of the grinder bodies having concave portions are defined by the intersection of the sphere (S) of radius R of each of said grinder bodies and a sphere (S′) having a radius (R′) substantially greater than the radius (RM) of the grinder bodies of greatest diameter.

13/ A mill according to claim 12, wherein the radius (RM) of the largest diameter grinder bodies is 45 mm, and the radius (Rm) of the smallest diameter grinder bodies is 30 mm.

14/ A set of grinder bodies according to claim 12, wherein the radius (RM) of the largest diameter grinder body is 35 mm, and the radius (Rm) of the smallest diameter grinder bodies is 30 mm.
